(19) United States
(12) Patent Application Publication
(10) Pub. No.: US 2003/0200322 A1
(43) Pub. Date: Oct. 23, 2003

(54) Autonomic system for selective administation isolation of a secure remote management of systems in a computer network

(75) Inventors: Philip Lee Childs, Raleigh, NC (US); Jeffrey Mark Estroff, Cary, NC (US); Michael T. Vanover, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: INTERNATIONAL BUSINESS MACHINES CORPORATION, Armonk, NY (US)

(21) Appl. No.: 10/063,402

(22) Filed: Apr. 18, 2002

(51) Int. Cl. G06F 15/16

(52) U.S. Cl. 709/229

(57) ABSTRACT

An autonomic system for selective administration isolation for more secure remote management in a computer network is disclosed. The aspects include isolating administrative access to managed client systems in a computer network via a data center, and utilizing the data center to control remote initiation of services in the managed client systems by an administrative system. Through the present invention, peer-to-peer management is avoided through the inclusion of a trusted third party in the form of a data center. User data privacy can be enforced and system configuration can be limited to administrator control, which are both accomplished under the enforcement of the data center. These and other advantages will become readily apparent from the following detailed description and accompanying drawings.

1. Field of the Invention

The present invention relates generally to management systems and more particularly to an autonomic system for selective administration isolation for more secure remote management of systems in a computer network.

2. Background of the Invention

Large-scale computer networks provide many types of services and applications, where typically there are one or more servers accessible by multiple end-users/clients. One consideration of computer networks is the utilization of an authentication protocol or mechanism to ensure that only authorized operations/access for a particular user occur. A further consideration is the establishment of system administrator(s) who are responsible for managing the computer network. Often management of the network occurs through remote management. Normally, remote management is done in a peer-to-peer arrangement, such as a remote console takeover of a client. With such a takeover, the system administrator has access to the client's operating system log-on information/security credentials.

The broad access to a client's system presents an opportunity for security breaches in a network, e.g., by a rogue acting as an administrator to infiltrate the network. Accordingly, what is needed is an approach for system administration of remote clients in a computer network that provides an administrator enough access to perform remote operations, both attended and unattended by a user of the remote client, without providing so much access that the security of the client or privacy of its user is compromised. The present invention addresses such a need.

### SUMMARY OF INVENTION

An autonomic system for selective administration isolation for more secure remote management in a computer network is disclosed. The aspects include isolating administrative access to managed client systems in a computer network via a data center, and utilizing the data center to control remote initiation of services in the managed client systems by an administrative system.

Through the present invention, peer-to-peer management is avoided through the inclusion of a trusted third party in the form of a data center. User data privacy can be enforced and system configuration can be limited to administrator control, which are both accomplished under the enforcement of the data center. These and other advantages will become readily apparent from the following detailed description and accompanying drawings.

### BRIEF DESCRIPTION OF DRAWINGS

FIG. 1 illustrates a diagram of a system for selective administration isolation in accordance with a preferred embodiment of the present invention.

FIG. 2 illustrates a block flow diagram of selective administration isolation in accordance with a preferred embodiment of the present invention.

### DETAILED DESCRIPTION

The present invention relates generally to management systems and more particularly to an autonomic system for selective administration isolation for more secure remote management of systems in a computer network. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

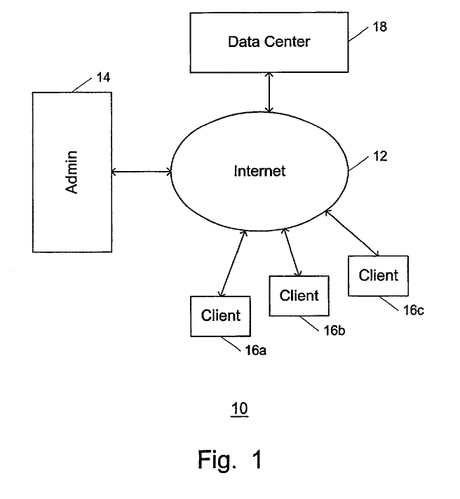

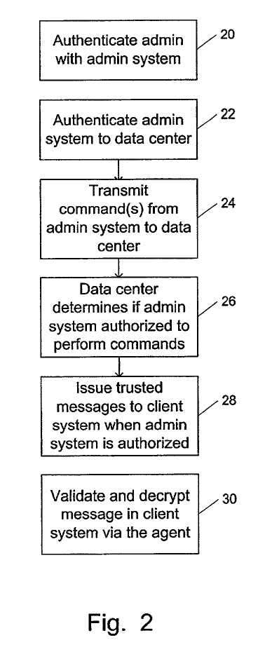

Referring to FIG. 1, a computer network system, in accordance with a preferred embodiment of the present invention, is illustrated. It should be appreciated that although the network system 10 is illustrated as being on a world wide web-based network 12, i.e., the Internet, this is illustrative and not restrictive of the arrangement for the network 10. Included in the network system 10 are one or more service administrator systems 14, e.g., a help center terminal for managing client systems 16, 16a, 16b or 16c, e.g., personal computers. Further included is a data center 18 that acts as a trusted third party for all accesses by the administrator 14 to any of the managed client systems 16, 16a, 16b or 16c, as described with reference to the block flow diagram of FIG. 2. The data center 18 suitably is provided on a computer system as part of a utility backbone for the network, e.g., as part of an e-business service utility to support Internet marketplace functionality, including, for example, services for trusted shopping, intelligent content management, databases, support routing, etc.

With reference to FIG. 2, in order to provide the actions of a trusted third party by the data center 18 for all administrator 14 accesses to managed clients 16, 16a, 16b or 16c administrator personnel are first authenticated to their respective computer systems (step 20). The authentication preferably includes the use of an embedded security chip as part of the hardware of the administrator systems to uniquely identify the system and biometric/badge authentication of its user, e.g., fingerprint touchpad to read the fingerprint of the administrator combined with the input of a proximity badge identifying the administrator. Once authenticated to their machine, the administrator systems are further authenticated to the data center 18 (step 22). Preferably, the communications between the administrators and the data center 18 are secured based on PKI (public key infrastructure) with VPN (virtual public network) and SSL (secure socket layer) protocol machine authentication, as is well understood by those skilled in the art.

Commands from the administrator systems 14, such as to do a back-up operation, restore files, etc. on a client system, are then transmitted to the data center 18 and verified by digital signature (step 24). The data center 18 then determines whether the administrator is allowed to perform the commands based on pre-existing data contained therein relating administrators and their approved capabilities (step 26). When the administrator does have approval to perform the command, the data center 18 issues an appropriately signed, trusted message to the intended client 16, 16a, 16b or 16c (step 28). In a preferred embodiment, the data center 18 communicates with an agent in the client system 16, 16a, 16b or 16c using a user ID and password known only to the data center 18 and agent and inaccessible to the user of the client system 16. The client system 16, 16a, 16b or 16c then validates the signature of the received message as being from the trusted third party (not the admin directly and decrypts the message via the agent (step 30). Thus, the system administrators never have direct access to the client's operating system log-ons or security credentials, even though working through the data center, the administrators are able to act as if they were a local administrator.

With the inclusion of the data center in accordance with the present invention, a control chain exists which allows services to be efficiently and securely run on any given client PC when remotely initiated only by the data center itself. Neither the administrator nor the user can take on the capabilities of the trusted third party, the data center. User data privacy can be enforced and system configuration can be limited to administrator control, which are both accomplished under the enforcement of the data center. The data center can remotely control a PC, under request of an authenticated administrator, and when necessary, on behalf of a user. Further, the ability to uniquely tie the administrator to a computer system as part of the authentication reduces the opportunity for unauthorized administrative use when that computer system is not present. In this manner, a high level of accountability exists, since actions of the administrator are directly related to a piece of equipment for which the administrator is already accountable as a business asset.

From the foregoing, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

1. A method for autonomic administration isolation for a secure remote management in a computer network, the method comprising the steps of:
(a) isolating administrative access to a plurality of client systems in a computer network via a data center; and
(b) utilizing the data center to control remote initiation of services in the plurality of client systems by an administrative system.

2. The method of claim 1 wherein the utilizing step (b) further comprises the step of (b1) verifying authentication of the administrative system by the data center.

3. The method of claim 2 further comprising the step of (b2) receiving service commands from the authenticated administrative system in the data center.

4. The method of claim 3 further comprising the step of (b3) determining in the data center whether the authenticated administrative system has authorization to perform the service commands in the managed client systems.

5. The method of claim 4 further comprising the step of (b4) issuing trusted messages from the data center to the managed client systems when the authenticated administrative system does have authorization to perform the service commands.

6. The method of claim 5 further comprising (c) validating and decrypting the trusted messages in the managed client systems to perform the service commands.

7. An autonomic system for selective administration isolation for secure remote management in a computer network, the system comprising:
a network;
at least one administrator system coupled to the network;
at least one client system coupled to the network; and
a data center coupled to the at least one administrator system and to the at least one client system via the network, the data center for isolating administrative access to the at least one client system and controlling remote initiation of services in the at least one client system by the at least one administrative system.

8. The system of claim 7 wherein the at least one administrator system includes authentication capabilities via an embedded security chip for unique system identification and biometric identification for unique user identification.

9. The system of claim 7 wherein the data center verifies authentication of the at least one administrative system.

10. The system of claim 9 wherein the authenticated at least one administrative system sends service commands to the data center.

11. The system of claim 10 wherein the data center determines whether the authenticated administrative system has authorization to perform the service commands in the at least one client system.

12. The system of claim 11 wherein the data center issues trusted messages to the at least one client system when the authenticated administrative system does have authorization to perform the service commands.

13. The system of claim 12 wherein the at least one client system validates and decrypts the trusted messages to perform the service commands.

14. The system of claim 9 wherein the network further comprises a world wide web network.

15. A computer readable medium containing program instructions for autonomic administration isolation in a computer network for a secure remote management, the program instructions for:
(a) isolating administrative access to a plurality of client systems in a computer network via a data center; and
(b) controlling remote initiation of services in the plurality of client systems by an administrative system via the data center.

16. The computer readable medium of claim 15 further comprising (b1) verifying authentication of the administrative system by the data center.

17. The computer readable medium of claim 16 further comprising (b2) receiving service commands from the authenticated administrative system in the data center.

18. The computer readable medium of claim 17 further comprising (b3) determining in the data center whether the authenticated administrative system has authorization to perform the service commands in the managed client systems.

19. The computer readable medium of claim 18 further comprising (b4) issuing trusted messages from the data center to the managed client systems when the authenticated administrative system does have authorization to perform the service commands.

20. The computer readable medium of claim 19 further comprising (c) validating and decrypting the trusted messages in the managed client systems to perform the service commands.
